(19) United States
(12) Patent Application Publication
(10) Pub. No.: US 2010/0137141 A1
(43) Pub. Date: Jun. 3, 2010

(54) Methods and Products to Protect Against Root Intrusion and Plant and Root Growth

(76) Inventors: Edward S. Lipinsky, Fairview, NC (US); Dominic A. Cataldo, Kennewick, WA (US); Peter VanVoris, Daniel Island, SC (US)

Correspondence Address: MUELLER AND SMITH, LPA;MUELLER-SMITH BUILDING, 7700 RIVERS EDGE DRIVE, COLUMBUS, OH, 43235, US

(21) Appl. No.: 12/632,167

(22) Filed: Dec. 7, 2009

Related U.S. Application Data
(63) Continuation-in-part of application No. 10/899,956, filed on Jul. 27, 2004.
Application No. 10/899,956 is a continuation-in-part of application No. 10/438,559, filed on May 15, 2003, now Pat. No. 7,012,042.
(60) Provisional application No. 60/380,584, filed on May 15, 2002.

(51) Int. Cl. A01N 25/00; A01N 41/06; A01N 33/18

(52) U.S. Cl. 504/333; 504/347; 504/358; 504/360; 504/361

(57) ABSTRACT

Method for forming a control device for control of one or more of root intrusion or plant growth commences by heating a root-controlling agent to its melting point temperature and heating a nanoclay intercalated with an ammonium ion to a temperature of at least the root-controlling agent melting point temperature. The heated root-controlling agent is loaded with the heated intercalated ammonium ion intercalated nanoclay to form a composite material that is partially exfoliated. The particle size of said composite material is adjusted for blending and further exfoliation. The particle size of the composite material is adjusted with a polymer matrix. The nanoclay in the polymer matrix is exfoliated to an extent that a slow controlled release of the root-controlling agent from the polymer matrix is obtained. Finally, the polymer matrix is formed into a fiber to form the control device.

### CROSS-REFERENCE TO RELATED APPLICATIONS

This application is a continuation-in-part of application Ser. No. 10/899,956, filed Jul. 27, 2004; which is a continuation-in-part of application Ser. No. 10/438,559, filed May 15, 2003, now U.S. Pat. No. 7,012,042; which claims benefit of provisional application Ser. No. 60/380,584, filed May 15, 2002; and is cross-referenced to application Ser. No. 10/816,095, filed Apr. 1, 2004; the disclosures of which are expressly incorporated herein by reference.

### STATEMENT REGARDING FEDERALLY SPONSORED RESEARCH

Not applicable.

### FIELD OF THE DISCLOSURE

This disclosure is directed to the field of nanoparticle-filled fibers, fabrics, and coatings for prevention of root intrusion and control of plant growth via controlled sustained release of a bioactive agent.

### BACKGROUND OF THE DISCLOSURE

There is considerable patent and technical literature concerning polymeric fibers that contain solid particulates within the fibers. Examples include inclusion of small amounts of titanium dioxide in polyester fibers as a delustrant and use of silicon dioxide particles to enhance the gloss of polyester fibers. Magnetic fibers have been reported that are thermoplastic fibers loaded with cobalt alloys. A recent patent in this area (U.S. Pat. No. 6,723,378) makes use of void volume associated with porous fiber strands and/or voids that exist between a multiplicity of single fiber strand that are twisted to form a fiber. U.S. Pat. No. 6,127,028 uses melt spinning of mixtures of molten thermoplastics with finely divided metals or metal oxides to produce cut resistant fabrics. None of this prior art pertains to desorption and diffusion processes.

U.S. Pat. No. 6,607,994 does pertain to controlled release using nanoparticle-based permanent treatments for textiles; however, the particles cling to the outside of the fibers and require a covalent bond between the fiber and the nanoparticle.

U.S. Patent Application 20030092817 describes pesticide formulations in which the active ingredient is sorbed into carbon black and a nanoclay is employed to increase the tortuosity of the diffusion path of the pesticide in its transport from the carbon black carrier to the environment.

U.S. patent application Ser. No. 10/816,095 (cited above) does provide a technology for making the nanoparticles needed for this disclosure and is incorporated into this application by reference. In it, intercalation of a 2,6-dinitroaniline into montmorillonite and/or a nanoclay made from a smectite mineral is followed by exfoliation of the sorbed product in a polymer matrix or a monomer that is converted to a polymer matrix. The nanoclay that is loaded with 2,6-dinitroaniline is converted to a powder that is suitable for use in the present disclosure.

U.S. Pat. No. 5,421,876 proposes an organoclay-filled asphaltic polyurethane dispersion. In column 8, lines 41-44, additives are mentioned that include insecticides and fungicides. This prior art is distant from the Applicant's disclosure in that the additives are not sorbed onto the nanoclay; the nanoclay's role is to stabilize the asphalt dispersion. The dispersion is expected to release the additives much more rapidly than the products of the Applicant's disclosure.

Although U.S. patent application Ser. No. 10/816,095 provides a method for loading the active ingredient into a nanoparticle, successful use of said particles to produce fibers and fabrics that prevent root intrusion over long time periods is lacking. It is to such development that the present disclosure is addressed.

### BRIEF SUMMARY OF THE DISCLOSURE

One aspect is a control device for control of one or more of root intrusion or plant growth. Such control device is a fibrous product formed in the presence of and containing an exfoliated nanoclay, which nanoclay retains an ammonium ion chemical having 6 or more carbon atoms and which nanoclay is loaded with a 2,6-dinitroaniline. The fibrous product is manufactured by heating a nanoclay intercalated with an ammonium ion. Next, 2,6-dinitroaniline is heated. The heated intercalated ammonium ion intercalated nanoclay is loaded with the heated 2,6-dinitroaniline to form a composite material that is partially exfoliated. Next, the particle size of said composite material is adjusted for blending and further exfoliation. The particle size adjusted composite material is blended with a polymer matrix. The nanoclay in said polymer matrix is exfoliated to an extent that a slow controlled release of the 2,6-dinitroaniline from the polymer matrix is obtained. Finally, the nanoclay/polymer matrix is formed into a fiber to form the control device. The control device may take form of a geotextile, coating, a caulk, a film, a sealant, or a gasket.

Desirably, the intercalated nanoclay is heated to a temperature equal to or greater than that of the heated 2,6-dinitroaniline. Such heating may be to about 1° C. above the temperature of the heated 2,6-dinitroaniline, and can be about 5° C. to 10° C. above the heated 2,6-dinitroaniline. The 2,6-dinitroaniline in turn may be heated to a temperature that is equal to or greater than about 1° C. above its melting point to about 50° C. above its melting point. Such 2,6-dinitroaniline heating may be about 5° C. to about 40° C. above its melting point. Such 2,6-dinitroaniline heating may be about 30° C. above its melting point.

The particle size adjustment may be from about 250 microns to about 35 microns for melt spinning. The particle size adjustment may be from about 75 microns to about 20 microns for injection molding.

The fiber may be formed by melt spinning in the presence of the exfoliated nanoclay or by a film-to-fiber process in which an intercalated nanoclay containing 2,6-dinitroaniline is exfoliated in a thermoplastic polymer melt and formed into a film that is slit and twisted to form fibers. The fiber also may be formed by one or more of extrusion, casting, injection molding, calendaring, or blow molding.

Repellent devices and methods for control of root intrusion and plant growth include a geotextile in which for formed fibers are placed. Control of the rate of release (retardation of the rate of release) of the 2,6-dinitroaniline is achieved from the fibers.

### BRIEF DESCRIPTION OF THE DRAWINGS

For a fuller understanding of the nature and advantages of the present device and method, reference should be had to the following detailed description taken in connection with the accompanying drawings, in which:

FIG. 1 graphically portrays dichlobenil release profiles for test rods held at 45° C., as report in Example 5; and

FIG. 2 graphically portrays dichlobenil release profiles for test rods held in air at 25° C., as reported in Example 5.

These drawings will be described in further detail in Example 5, below.

### DETAILED DESCRIPTION OF THE DISCLOSURE

Much of the description herein is by way of illustration using 2,6-dinitroaniline. It should be recognized, however, that such description is not a limitation, as a variety of root-controlling chemicals find use in the present disclosure. Other effective agents include, such as, for example, sodium methyldithiocarbamate (metam-sodium), methyl isothiocyanate, and copper sulfate. Note should be taken that sodium methyldithiocarbamate may decompose to generate methyl isothiocyanate. Likely, other effective root-controlling agent will be apparent to those skilled in the art based on the present disclosure.

### Loaded Melt Spun Fibers

The major cornerstone of the fiber aspect of this disclosure is the method by which 2,6-dinitroaniline-loaded nanoparticles can be embedded successfully in melt spun fibers. The method must meet stringent criteria: the spinnerettes must not be clogged by the particles, which means that the size and size distribution of the particles must be controlled to specified limits. The particles must not agglomerate to a size that would cause clogging. The particles must retain most of the 2,6-dinitroaniline at temperatures above 120° C. that are used for spinning. The particles must have a high holding capacity for the active ingredient, and they must release the active ingredient slowly. The polymer must melt at a temperature that is below the degradation temperature of the active ingredient or a means to circumvent this limitation must be found. In addition, interaction of the particles with the polymer must not increase the viscosity of the spinning fluid beyond the limits imposed by the melt spinning process. The strength and other mechanical properties of the loaded fiber must be adequate to meet the requirements of rugged geotextile products. These parameters have been defined, based on the experiments reported herein.

An alternative to melt spinning is film-to-fiber formation processes, which involve extrusion of a thermoplastic film or sheet. The film is slit or cut and then twisted to produce a fiber. Some film-to-fiber processes use chemomechanical fibrillation to make fibers directly from the film.

The preferred 2,6-dinitroanilines include, but are not limited to one or more of trifluralin, oryzalin, pendimethalin, isopropalin, diniramine, fluchloralin, benefin, or dinoseb.

The preferred clays include, but are not limited to, one or more of smectite, montmorillonite, beidellite, nonttronite, saponite, or sauconite. For present purposes, minerals with a high percentage (e.g., greater than about 70%) of smectite or other clay, such as, for example, bentonite (about 88% montmorillonite), are included within the definition of “clays”. The preferred nanoclays are those that are derived from the aforementioned clays by reaction with onium salts, especially ammonium salts, including, for example, Nanomers from Nanocor, Inc. and Closites from Southern Clay products, such as:
Nanomer I.30E (70%-75% Montmorillonite; 25%-30% protonated octadecylamine;
Nanomer I.30P (70%-75% Montmorillonite; 25%-30% protonated octadecylamine;
Nanomer I.34TCN (65%-80% Montmorillonite; 20%-35% methyl tallow bis(2-hydroxyethyl) ammonium salt;
Nanomer I.44PA (77% Montmorillonite; 23%-30% dimethyl dialkyl [C14-C18] Ammonium salt;
Nanomer PGV (100% Montmorillonite);
Closite 10A benzyldimethyl hydrogenated tallow ammonium chloride;
Closite 30 B methyl, tallow, bis-2-hydroxyethyl, quaternary ammonium chloride.

The preferred polymers for melt spinning for fiber production in this disclosure include, but are not limited to, one or more of the following thermoplastics: polypropylene, polyethylene, ethylene/propylene copolymers, polyethylene terephthalate, polytrimethylene terephthalate, polyamides, polycaprolactone, polylactic acid, lactic acid-glycolic acid polyesters, or poly(3-hydroxy butyrate). The same polymers are preferred for the film-to-fiber processes. Fibers made from these thermoplastics are “filled” by including a 2,6-dinitroaniline-loaded clay or nanoclay in the thermoplastic melt that is formed into the fibers either by melt-spinning or by film-to-fiber processes.

Fabrics from Loaded Melt Spun Fibers

The second aspect of this disclosure pertains to nonwoven and woven fabrics that contain the 2,6-dinitroaniline-loaded fibers described in the first aspect. The output of the melt spinning process can be spun-bonded nonwoven fabrics in which fabric production is integrated with fiber production. Alternatively, staple fibers can be made via melt spinning, followed by chopping into lengths that are suitable for the application. The staple fibers then can be processed into nonwoven or woven fabrics that will prevent root intrusion. The novelty of these products arises from the novel loaded fiber and also from the blending of strong unfilled fibers with the weaker loaded fibers and the processing to achieve the end use requirements of geotextile markets. In addition, 2,6-dinitroaniline can be transferred from the initial fibers to unfilled fibers in the nonwoven or woven product while the product is in use. Some end uses benefit from formation of a multifilament fiber for use in the geotextile. Other end uses benefit from combinations of unfilled fibers and 2,6-dinitroaniline-loaded fibers.

The preferred unfilled fibers that are meltspun have been listed above. Those that are not melt spun (that is, biosynthesized or dry spun or wet spun) and that are blended with chopped melt spun fibers include, but are not limited to, one or more of the following natural polymers: cotton, rayon, cellulose pulp, flax, jute, hemp, or wool. Synthetic polymers that are candidates for use as unfilled fibers include, for example, one or more of cellulose acetate, vinyls, or acrylics.

Spray Urethanes with Loaded Nanoclay Fibers

The third aspect of this disclosure is the use of the 2,6-dinitroaniline-loaded clay fiber particles in coating formulations, especially spray formulations. Spray nozzles are not as sensitive as spinnerettes are, but clogging can be a problem in this method of application. Therefore, the use of thin, orientable nanoparticles in this application is highly desirable. The combination of high holding capacity and slow release renders the nanoparticles of this disclosure quite useful in coatings for geotextiles, sewer pipes, and plant growth regulator applications.

The 2,6-dinitroaniline-loaded nanoclay particles are meltspun with polyolefin to form a loaded, e.g., polypropylene or polyethylene continuous fiber product. This product is one of the First Aspect materials. The spraying device that uses the continuous fiber has a chopper that produces short fiber segments in the space above the mixing chamber of the sprayer. The length of the chopped fibers is about 6 mm or less. The chopped fibers are intimately mixed with the isocyanate and polyol ingredients just prior to spraying. This method is similar to that used in chopping and incorporating short glass fibers into polyurethane automobile parts. The spraying operation makes use of the adhesive properties of polyurethane to form a coating on geotextile fabrics or soil or pipes.

In another embodiment, two polymer sheets can be glued together by spraying with the above-described polyurethane adhesive that contains the fibers that are loaded with 2,6-dinitroaniline-loaded nanoclay particles. The product can be needle-punched to form a nonwoven fabric.

The third aspect also includes an improved geotextile product and process that uses powder coating or ink jet technology to make available films or sheets that have specified amounts of 2,6-dinitroaniline-loaded nanoclay fibers, optionally admixed with load nanoclay (sans fiber), spread over its area and contained at a specified depth beneath its surface. The product comprises three layers. The top and bottom layers are thermoplastic polymer sheets or films. The middle layer is a coating of 2,6-dinitroaniline-loaded nanoparticles of this disclosure. The layers are welded together thermally or by use of an adhesive. The product can be needle punched to form a superior geotextile to prevent root intrusion.

Also, as used herein, “polyurethane” and “polyurethanes” include and mean polyurethanes, polyureas, polyetherureas, polyisocyanurates, polycarbodiimides. Such polymers are prepared by polyaddition of nucleophiles (e.g., polyols, polyamines, water) to form polyisocyanates that contain two or more isocyanate groups, and combinations thereof.

### Loaded Staple Fibers in Multi-Ply Geotextiles

The fourth aspect of this disclosure uses 2,6-dinitroaniline-loaded nanoparticles that are in fibers that are sandwiched between polymer sheet layers that are converted to nonwoven products. Polyolefin staple fibers form a desorbent fluff that supplies 2,6-dinitroaniline that repels roots from intruding into a geotextile product.

The loaded staple fibers are produced by the methods described in the First Aspect of this disclosure. Thus, the raw materials are those described therein. The staple fibers may be purchased or continuous loaded fibers can be chopped to the desired length during manufacture of the geotextile product.

The fluff is distributed to one outer layer of the geotextile and then trapped within the structure by placing the other layer upon it. Needle punching is employed to provide holes through which water can percolate. This operation also reduces migration of the fluff within its layer.

### Loaded Fiber Reinforced Acrylamide Gel Products

In this fifth aspect of the disclosure, a formulation of a polymer gel that contains a fibrous reinforcement provides a product for use in one or more of the following applications: repairing pipe, a grout for pipe, or a soil stabilizer. The improvement for one or more of root intrusion or root growth when said coated pipe is placed underground, is achieved by incorporating into the formulation, fibers loaded with a 2,6-dinitroaniline-loaded nanoclay.

Placement of the 2,6-dinitroaniline-loaded nanoclay within a fiber avoids partial destruction of the 2,6-dinitroaniline by free radicals that are used to initiate the polymerization and crosslinking reactions that result in the gel product. Also, the exposed 2,6-dinitroaniline in the loaded nanoclay can terminate the polymerization and crosslinking reaction free radical intermediates.

Thus, there are distinct advantages in adding fibers loaded with a 2,6-dinitroaniline-loaded nanoclay to a formulation for making acrylamide gels. The fibers to be used in this aspect of the disclosure include those that are fibers or continuous rolls of fiber that are chopped to the appropriate length at the site.

### Preparation of 2,6-Dinitroaniline-Loaded Nanoclay Fibrous Products

The initial step is preparation of the 2,6-dinitroaniline-loaded nanoclay reservoir by the sorption methods taught by U.S. patent application Ser. No. 10/816,095. The reservoir material can be dispersed as platelets either in liquefied monomers or polymers. The loaded monomer is polymerized to yield a loaded polymer. These two options are not necessarily equivalent because it may be preferable to exfoliate the nanoclay in a monomer that is less viscous than the molten polymer or the molten polymer may have to be at a temperature beyond 2,6-dinitroaniline's stability limit. Dispersion in the monomer is not always preferable because some monomers could react with 2,6-dinitroaniline. The reactive functional groups would not present in the polymer.

The next step can be to produce directly fibers or films or molded products from the loaded polymer. As examples: Loaded fibers can be made by melt spinning. Loaded film or sheet materials can be made by extrusion. Injection molding or casting can be used to make thicker objects. Loaded fiber production is the most challenging and is discussed below.

To meet the stringent mechanical and environmental performance requirements of geotextiles, the loaded fiber or film products usually must be modified or formulated in special ways. For example, the geotextile may use a mixture of 2,6-dinitroaniline-loaded polypropylene fibers and non-loaded polyester fibers. The percentage of each type of fiber and the location of the 2,6-dinitroaniline-loaded polypropylene fibers need to be determined.

The loaded polymer also can be used in a sprayable formulation that can circumvent manufacturing and end use problems that could arise through direct conversion of the loaded polymer into a shaped object. The spray formulation may be a polyurethane or a latex polymer (e.g., styrene acrylic or vinyl acrylic) that are especially easy to spray. The sprayable formulation provides thin effective coatings for shapes that are too complex for molding, for substrates that are not located in a manufacturing environment (e.g., a basement floor in a residence). Unfilled fibers, films, sheets, and moldings can receive a thin coating of 2,6-dinitroaniline-loaded polymer that can protect the shaped object for years from root intrusion. Spray technology also can generate relatively thick slabs that can protect buildings from intrusion by roots and termites.

While the disclosure has been described with reference to preferred embodiments, those skilled in the art will understand that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims. The following examples show how the disclosure has been practiced, but should not be construed as limiting. In this application all units are in the metric system and all amounts and percentages are by weight, unless otherwise expressly indicated. Also, all citations referred herein are expressly incorporated herein by reference.

### Example 1

### 2,6-Dinitroaniline/Nanoparticle-Loaded Fibers

In preparation for spinning loaded fibers, the 2,6-dinitroaniline-loaded nanoclay was prepared from Dow Agro Science's Treflan® (Trifluralin or TFN) and Nanocor's I.30P nanoclay. The sorption method of U.S. application Ser. No. 10/816,095 was used. The particle size requirement was that the sample passes through a #60 U.S. Sieve (<250 microns). The product was further ground to about 25-35 micron size. Pelletized polypropylene material was used for the extrusion and spinning of fibers. It was exfoliated by blending the loaded nanoclay with Microthene® polypropylene and extruding the mixture into the melt spinning device. During melt spinning to prepare 77-micron diameter fiber, the platelets became oriented on passing through the spinnerettes.

A geotextile product was prepared by loading the trifluralin/nanoclay/polypropylene fiber material into a polyester matrix that was adjusted to provide between 4 and 8% TFN (w/w) for the first fiber run, and 3% TFN (w/w) for the second test run. These samples were placed in a flow device that exposed the sample to water that contained 0.01% Tween 20. It was operated at room temperature (ca. 23° C.). These conditions are used as an accelerated test in which 24 hours represents 2 or 3 years of exposure in the environment.

Samples run in the accelerated system at 25.5° C. utilized a 2-hour extraction in 10% MeOH to remove external TFN residing on the outside of the fibers. Results were gathered for some 28 days. Steady state (relatively constant release rate) was attained in about 6 days. Extractions to determine total TFM were done on three samples that were the 40% and 60% battings, and the feed fiber containing the TFN at 3.3% initial loading. The Bat-40 has 40% (w/w) of the TFN treated fiber, with the balance polyester fiber, while the Bat-60 has 60% (w/w) treated fiber. All calculations are based on these values, along with the actual TFN remaining in the fiber after production.

The release rates for the TFN-loaded nanoclay filled polypropylene fibers ranged from 1 micronsg/cm²/day to 3 micronsg/cm²/day. These fiber release rates compare favorably with those obtained with films and sheets containing TFN-loaded nanoclay, as shown in Table 2 in Example 2.

This is a quite surprising result because the diffusion path from the reservoir to the surface is much less for a fiber than for the injection molded sheets made for comparison purposes. One hypothesis for these results is that the spinning process orients the individual platelets into a single file of particles that lay flat along the axis of the cylindrical fiber. This orientation maximizes the diffusion path to the surface. Also, there may be interaction between the clay particles and the polypropylene matrix that would reduce the void volume of the matrix. This phenomenon is well known in nanoclay science, due to observations that oxygen and other gases diffuse more slowly in polymer films when the films contain the same types of nanoclays as used in this example. However, the phenomenon may be accentuated in thin fibers, compared with films.

### Loading Rates

Extractions of the three TFN configurations described above were undertaken in triplicate. The TFN feed fiber contained 23.3±1.5 mg TFN/gm fiber, or 2.3% TFN. The feed material initially contained 8% TFN/nanoclay, or 3.3% TFN. This loss is consistent with the losses noted at the extrusion die during preparation of the samples.

### Longevity Estimates

Table 1 provides the tabulation of pertinent data used in the longevity estimates. Note that longevity estimates are based on recovered TFN in the total battings and not just the TFN fiber in the battings. Thus, we anticipated that some TFN would migrate into the polyester fibers in the batting. The release rate is a function of diffusion of TFN from the near fiber surface to the receiving solution or soil. Any accumulation of TFN adjacent to or on the surface of the treated fiber, results in a slowing of the release rate, and a subsequent increase in longevity. In our accelerated extraction/perfusion systems, we try to maximize release by carrying TFN away from the solution/fiber interface. This gives us, in effect, a zero order release rate; or in our case the worst case/highest possible release rate and lowest longevity. In this instance, the test ran for about 30-days at 78° F.

All samples showed an increased release rate with contact with fresh solution, then rapidly settled down to a much lower steady state value at day 2, 3, etc. This appears to involve the expected diffusion feedback based on concentration of TFN at the fiber surface. What is surprising is that the TFN at the surface of the fiber is removed so thoroughly by the fresh solution, while the solution is so much less effective in removing TFN after the first day.

In Table 1, the TFN concentrations in the fiber and batting samples are tabulated by extracting them as a unit. These indicate an approximately 30% loss of TFN in the extrusion/spinning process. All longevity estimates include this loss. Any decrease in this loss rate will increase longevity proportionately.

The calculated longevities are tabulated as maximum, nominal, and minimum. The minimum estimated are based on the zero time-release rates (highest) and uncorrected for external build-ups of TFN as discussed above. Corrected longevities are tabulated in parentheses. The nominal and maximum longevities are based on 3- and 12-day accumulations of TFN within the perfusion solutions. The release rates actually decrease, increasing calculated longevity. Based on 25 years of prior work with these systems, our best estimate of longevity lies somewhere between the maximum and nominal values, and are consistent with 15 year longevity, at 78° F.

TABLE 1
Parameters and Estimates Related to TFN-Containing Samples

| % TFN | | | Longevity (years) | | |
|---|---|---|---|---|---|
| Sample | Calculated | Actual | Maximum | Nominal | Minimum |
| TFN Fiber | 3.3 | 2.3 ± 1.5 | 8.2 | 6.4 | 2.1 (5.3) |
| Bat-40 | — | 0.97 ± 0.1 | 12.1 | 10.7 | 4.1 (10.2) |
| Bat-60 | — | 1.4 ± 0.05 | 14.1 | 12.3 | 4.2 (10.5) |

An unexpected observation in these data is the relative behavior of the fiber with and without batting. Bat-40 and Bat-60 contain batting, while TFN Fiber does not. The calculated longevities of the fiber alone were expected to be close to the fiber/batting samples. But the longevities consistently run low with respect to longevity (higher release rate). The batting is acting as a secondary reservoir that receives part of the TFN that is released from the TFN fiber and stores it for later release.

These data support that the 2,6-dinitroaniline-loaded nanoclay particles provide excellent release rates and longevities that are needed to prevent root intrusion. This goal is attained without great detriment to the mechanical properties needed for geotextile applications. This performance is in contrast to the properties of ordinary fibers that are loaded with solids. In addition, feasibility has been shown for use of fiber blends that have TFN fibers that spread their TFN to neighboring fibers to improve resistance to root intrusion. Thus, TFN can be stored in polyethylene terephthalate polyester fibers without having to expose the trifluralin to the high temperature needed for melt spinning of this polymer.

The color of the fiber product is adjusted to meet design specifications for the intended application by colorization of the melt that is used for the spinning operation. A black or green or brown dye is selected.

### Example 2

### Trifluralin/Nanoparticle-Loaded Film and Sheet

### Holding Capacity

Trifluralin was preheated above its melting point and slow-blended into preheated clay or nanoclay, using the procedure detailed in U.S. patent application Ser. No. 10/816,095, to wit:

Trifluralin (Treflan® from Dow Elanco) was heated to 68°-70° C., at which point it melted. A Blakeslee mixer (Model B-20) was adapted to have its interior heated to the desired temperature. The temperature of the clay and added pesticide within the bowl was maintained using heating straps attached to the outside mixing bowl (heaters controlled at 65° C., actual temp of stirred clay pesticide mixture was 50° C.). The nanoclay was slowly added to the mixer bowl at a rate of 5 mL/min-10 mL/min, with the mixer at a low (1) blending setting. Addition of the trifluralin was halted when the mixture just started to ball up. Mixing was continued for another hour at a higher mixing setting to break smaller clumps. The mixture then was cooled to room temperature, passed through a #60 sieve (<250 microns); remaining clumps (<10% total weight) were gently ground in a 1-quart Waring blender.

Liquid active ingredients (liquid at room temperature) were treated by the same procedure, except that the materials were not heated and cooled.

These procedures do not use water or organic solvents, as is customary in intercalating and exfoliating clays.

The results are recorded in Table 2.

TABLE 2
Trifluralin-Loaded Clay Holding Capacity

| | INTERCALATING | HOLDING | |
|---|---|---|---|
| CLAY or NANOCLAY | AGENT | CAPACITY⁽¹⁾ | STATUS |
| Bentonite Clay | None | 0.41 | Good mix; swells |
| Nanocor N I.34TCN | Dihydroxyethyl | 0.39 | Good mix; swells |
| | Ditallow | | |
| | Ammonium | | |
| Nanocor N I.44PA | Dimethyl di(C14- | 0.37 | Good mix; swells |
| | C18)alkyl | | |
| | Ammonium | | |
| Nanocor N I.30E | Octadecylamine | 0.46 | Good mix; swells |
| Nanocor N I.30P | Octadecylamine | 0.42 | Good mix; swells |
| Nanocor PGV | None | 0.44 | Liquid on surface |
| (Montmorillonite clay) | | | |

⁽¹⁾Gm active/(gm active + clay) (e.g., 1/1 = 0.5, 2/1 = 0.66, 3/1 = 0.75, 4/1 = 0.8)

The three-ammonium salts that were used to make the loaded products differ in their chemical structures, but all have hydrophobic groups attached to a nitrogen atom that carries a positive charge. Protonated octadecylamine has one long alkyl chain and three hydrogen atoms attached to the nitrogen atom. Dihydroxyethyl ditallow amine has two long alkyl chains and two short chains that terminate in hydroxy groups attached to the nitrogen atom. Dimethyl di(C₁₄-C₁₈)alkyl amine has two long chains and two short chains attached to the nitrogen atom.

Despite the differences in structure, all of these clays and nanoclays have about the same holding capacity for trifluralin ±10%. All of them mix well with molten trifluralin. The swelling indicates that trifluralin expands the clay galleries.

### Release Rates

The trifluralin-loaded clays were dispersed in molten polyethylene and polypropylene and injection molded into sheets, as described in U.S. patent application Ser. No. 10/816,095. A flow device was employed to measure the release rates of trifluralin from these composite materials. A summary of these data is shown in Table 3.

TABLE 3
Release Rates Of Trifluralin-Loaded Clays

| | | RELEASE RATE |
|---|---|---|
| SAMPLES | CLAY* | (MICRONSG/CM²/DAY) |
| Polyethylene (MA 778-000) | ATTP | 17.49 |
| Polyethylene (MA 778-000) | PGV | 12.5 |
| Polyethylene (MA 778-000) | N I.44PA | 11.47 |
| Polyethylene (MA 778-000) | N I.30P | 7.73 |
| Polypropylene (MU 763-00) | N PGV | 0.9 |
| Polypropylene (MU 763-00) | NI.44PA | 1.07 |
| Polypropylene (MU 763-00) | N I.30P | 0.41 |

*ATTP is attapulgite, a clay that swells well and is used in fertilizer formulations. Nanocor's PGV is a montmorillonite produced by purification of bentonite. The other clays are the reaction products of montmorillonite with aliphatic ammonium salts. They are called nanoclays.

The release rate of trifluralin-loaded attapulgite clay is much higher than the other products, because this clay has a needle structure instead of the platelet structure of the montmorillonite clay product. The lowest release rates by far in the two polymer systems were obtained with Nanocor's I.30P. It is noteworthy that montmorillonite clay has release rates that rival the release rates for the much more expensive I.44PA product made from dimethyl di(C₁₄-C₁₈)alkyl ammonium salt reaction with montmorillonite. We hypothesize that trifluralin is able to intercalate montmorillonite without need for ammonium ion pretreatment because trifluralin's structure has two polar nitro groups and an amino group.

The release rates from polypropylene were 11 to 19 times lower than release from polyethylene. Thus, both the structure of the clay component and the polymer matrix material are important in determining the release rates. These parameters can be manipulated to control the release of trifluralin to meet end use requirements.

The color of the film or sheet product is adjusted to meet design specifications for the intended application by colorization of the melt that is used for the extrusion operation. A black or green or brown dye is selected.

### Example 3

### Spray Coating with Trifluralin-Loaded Nanoparticles

In preparation for spraying trifluralin-loaded coatings, trifluralin-loaded nanoclay was prepared from Dow Agro Science's Treflan® trifluralin and Nanocor's I.30P nanoclay. The sorption method of U.S. patent application Ser. No. 10/816,095 was used. The particle size requirement was that the initial output passes through a #60 U.S. Sieve (<250 microns). The initial product was then ground and sieved to obtain particles that are less than 35 microns.

Rhino Linings, Inc.'s Tuff Stuff® sprayed-on polyurethane coating formulations that have the correct performance characteristics was selected for spray application. Its characteristics are 100 percent solids (therefore, no volatile organic solvent problems), cures in less than 10 minutes, have excellent longevity even in outdoor applications, and has excellent impact and abrasion resistance.

Rhino's spraying equipment has a single motor driving two separate fixed-ratio proportioning pumps. These pumps deliver Part A (an isocyanate component) and Part B (a polyol component) separately into a static mixing tube for airless spray operation for coating applications. Transfer efficiency of the equipment is 99%.

The coating can be sprayed onto the substrate that can be a geotextile or other fabric. It also can be applied to concrete, wood, or soil surfaces to prevent intrusion of roots.

The thickness of the thermoplastic elastomer coating can range from 1-mil films to 0.5-inch slabs. The Rhino device could be modified to deliver the reservoir component intermittently in thick coatings, so that the product would be more economical, and the longevity could be fine-tuned.

This procedure also was effective when polymerization of the mixture was conducted in a casting mode. Thus, 19 gm of part B was blended with one gram of trifluralin-loaded nanoclay. The loading of TFN was 40% in Nanocor's I.30 P. Then, 10 gm of Part A was added and the mixture was cast. This mixture set up within 2 minutes when Parts A and B were blended by hand. The product had a calculated longevity of 36 years, using a release rate of one micronsg/cm²/day.

The color of the spray product is adjusted to meet design specifications for the intended application by colorization of the mixture that is used for the spraying operation. A black or green or brown dye is selected.

### Example 4

### Acrylamide Gel Incorporating Trifluralin-Loaded Nanoparticles

A series of studies were undertaken with acrylamide gels with Nanocor I.30 P clays, and determine the efficacy of these formulations in lining of sewer pipes to prevent plant root intrusion.

Acrylamide gels were prepared from acrylamide, methylene bisacrylamide, sodium persulfate, and inhibitors. The gels were cast into cylinders with a surface area of 12.92 cm². Each 12.92 cm² cylinder was loaded with 0.125 gm TFN contained in 0.172 gm clay. The TFN/clay was mixed into 1 ml of the acrylamide, and stirred. One drop of 0.1% Tween 20 (a wetting agent), helped in particle dispersion. The crosslinking catalyst was added (1 mL), the mixture was stirred, and gelled. The crosslinked product is known as a “polyacrylimide). The dispersion of TFN/clay particles was uniform. The cylinders were removed from the casting cups, and placed into the perfusion system, which contained 0.1% Tween 20 in water, and assayed periodically for release rates.

The perfusion solution used (with wetting agent) increases the water solubility of the TFN from a nominal 0.2 ppm to approximately 100 ppm. This is done to accelerate TFN removal rates from the treated samples.

Table 4 provides the study results and the calculated performance estimates.

TABLE 4
Performance Results for the Acrylamide
Gel Systems Containing Nanocor 1.30P

| Longevity | Release Rate-Max | Expected Longevity |
|---|---|---|
| Configuration (Years) | (microg/cm²) | (years) |
| TFN Load-6% | | |
| Perfusion w/max solubility | 0.8 | 33 |
| Perfusion w/water alone | 0.6 | 66 |
| Calculated Application Behavior | 0.6 | 50 |
| 59% duty cycle | | |
| 20% detergent cycle | | |
| TFN Load-2% | | |
| Water alone | 0.4 | 22 |
| Sewage conditions | 0.6 | 14 |
| 59% duty cycle | | |
| 20% detergent cycle | | |

The longevity of the 6% loaded treatments were determined to be 33 years from the maximum TFN dissolution system, and 66 years based on adjustments for water solubility in the absence of wetting agents. Both of these values are based on cylinders and not the expected sheet configuration typical of a lining where losses would be expected to be less due to reduced surface area to volume.

In practice, the conditions within a sewer line are variable, there are periods where no water flows, and in this case TFN losses are reduced. On the other hand, there are instances in which detergents flush through and release rates increase. Any number of scenarios can be run, but all are based on reservoir size, TFN content, and the base release rates per unit area; the latter are pretty much fixed. The variable that helps to our advantage is that volatility losses to air are expected to be lower due to the limitations in water solubility, thus water flow is the driver for this system. If the TFN loading rate is reduced to 2% rather than the 6% used, the reservoir size is reduced, and projected longevities decrease to 14-22 years.

The color of the gel product is adjusted to meet design specifications for the intended application by colorization of the reaction mixture that is used for the gelling operation. A black or green or brown dye is selected.

The experiment described above provided desirable longevity results. However, this method allows 2,6-dinitroaniline to be exposed to the free radicals that catalyze the polymerization of acrylamide and its crosslinking reactions. It is likely that reacting with the catalyst will destroy some of the 2,6-dinitroaniline and that the polymerization/crosslinking reactions may be impaired.

The improvement provided in this disclosure is that the 2,6-dinitroaniline source be encapsulated within polypropylene or polyethylene fibers. The formulation would include the fibers and the usual ingredients for polyacrylamide gel products. The polymerization and crosslinking reactions would not affect the 2,6-dinitroaniline. Thus, a stronger gel and a higher concentration of 2,6-dinitroaniline are expected.

### Layered 2,6-Dinitroaniline/Nanoparticle-Loaded Composites

Many current state-of-the-art sustained release devices are made by dispersion of the active ingredient in a fluid polymer matrix (molten or solution), followed by conversion to a solid shaped object. This approach encounters technical and/or economic problems when the polymer has a high melting point or is sparingly soluble in solvents. This obstacle may be overcome by making multilayer composites in which the active ingredient is dispersed in a convenient fluid polymer that provides a film or sheet shape. This film/sheet then is adhered to other polymer layers that control release of the active ingredient. This approach also faces economic challenges, as well as technical problems.

The 2,6-dinitroaniline-loaded nanoclay reservoirs of this disclosure provide an improvement over the current state of the art through rendering feasible a variation on powder coating technology. The 2,6-dinitroaniline-loaded nanoclay particles are ground to a size range that is suitable for the end use application, usually about 20 microns or less to 75 microns. The particles are sprayed onto a substrate (film or sheet or more complex shape) using an electrostatic spraying device. For polymer matrices, a second layer can be applied to make a sandwich with the trifluralin-loaded nanoclay reservoirs trapped between the two polymer layers. These two layers can be welded together by pressing through nip rolls that are optionally heated. One or both of the layers can be made of fiber mats that are intermediates in the manufacture of nonwoven fabrics.

The 2,6-dinitroaniline-loaded nanoclay reservoirs do not have to be evenly distributed on the surface of the first polymer. They can be applied as a pattern that imparts the desired level of root-intrusion repellency and the desired longevity. This approach does not always require electrostatic spray technology. The 2,6-dinitroaniline-loaded nanoclay reservoirs can be delivered to the first surface by simple gravity feed onto a moving bed or by passing the substrate layer through rolls that dispense the 2,6-dinitroaniline-loaded nanoclay reservoirs and then compacts them.

The color of the geotextile product is adjusted to meet design specifications for the intended application by colorization of the top and bottom sheets. A black or green or brown dye is selected.

### Example 5

### Dichlobenil

Dichlobenil, like trifluralin, has a high vapor pressure, and also a significant water solubility of ˜40 ppm. Both vapor phase and aqueous phase release from a protected delivery system would be useful in agricultural applications, and control of roots within areas such as sewer lines.

Based on prior efforts with TFN, a flexible polyethylene and ethyl vinyl acetate (EVA, Equistar MU76000, mp 85° C.) and low-density polyethylene (LDPE, Equistar 70100, mp 102° C.) polymers with good diffusion porosity to actives such as TFN were selected. Thus, a series of studies were conducted to evaluate the use of EVA and LDPE with dichlobenil sorbed to various internal carriers, including standard mineral montmorillonite and I.30P nanoclay.

The formulations involved use of 5% and 20% (w/w) dichlobenil with equivalent clay. Thus, the actual concentration of dichlobenil was maintained at 5% and 20% dichlobenil within the polymer. Dichlobenil was sorbed to clays in a rotating drum heated to 155° C., about 5° C. above its melting point. The solid active was pre-melted to 160° C. and fed with a metering pump at 0.5 mL/min into the rotating drum containing clay. Mixing continued to maintain a friable state, and a total loading of 50%-60% dichlobenil in the clay. Samples were injection molded into 7.3 cm×0.63 cm rods. Rods were washed in 90% MeOH to remove the surface dichlobenil resulting from thermal extrusion. The protocol employed 2 polymers, 2 active concentrations per each of 2 formulations, and the 2 clays as noted.

The vapor phase release was determined at 45° and 25° C. These were gravimetrically assayed periodically to obtain the release rate in mg/cm²/day.

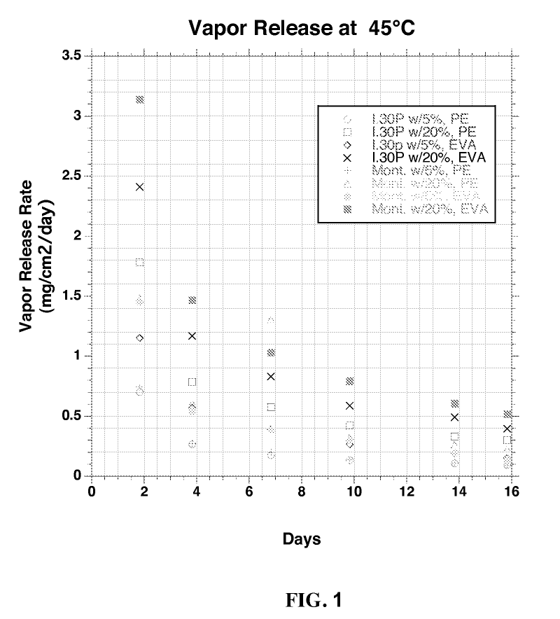

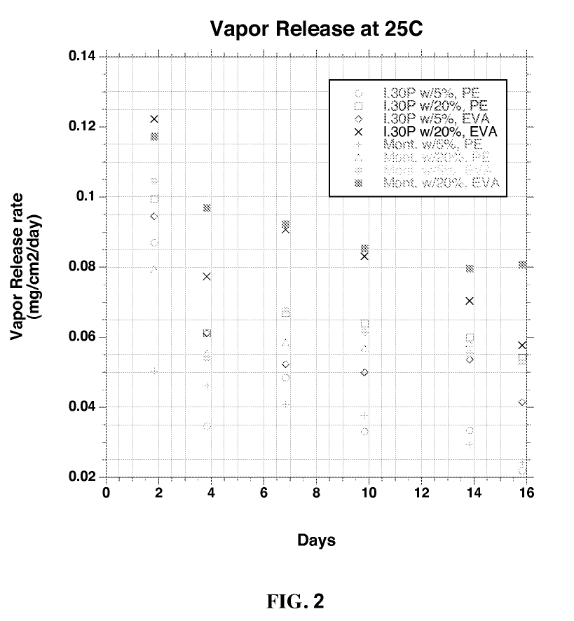

The vapor release profiles for the eight formulations are provided in FIGS. 1 and 2. At 45° C. and 25° C., the release rates for the various formulations show the declining release profiles typical of the early depletion of near surface active diffusion path distance and depletion. EVA exhibits a higher release rate than samples using LDPE, for both clays and both active concentrations. The release rate, as expected, is higher with increased dichlobenil loading. The I.30P loaded with dichlobenil exhibits a lower release overall compared to montmorillonite at near steady state. The fact that release rate can be controlled based on dichlobenil concentration and the form of the internal carrier (clay), indicates that devices can be manufactured to provide a range of dichlobenil release quantities to meet the needs of various agricultural and sewer protection needs, and environmental temperatures.

We claim:

1. A control device for control of one or more of root intrusion or plant growth, which comprises:
a fibrous product formed in the presence of and containing an exfoliated nanoclay, which nanoclay retains an ammonium ion chemical having 6 or more carbon atoms and which nanoclay is loaded with a root-controlling agent, said fibrous product being the product formed by the steps of:
(a) heating said root-controlling agent to its melting point temperature;
(b) heating nanoclay intercalated with an ammonium ion to a temperature of at least the root-controlling agent melting point temperature;
(c) loading said heated root-controlling agent with said heated intercalated ammonium ion intercalated nanoclay to form a composite material that is partially exfoliated;
(d) adjusting the particle size of said composite material for blending and further exfoliation;
(e) blending said particle size adjusted composite material with a polymer matrix;
(f) exfoliating the nanoclay in said polymer matrix to an extent that a slow controlled release of said root-controlling agent from said polymer matrix is obtained; and
(g) forming the polymer matrix of step (f) into a fiber to form said control device.

2. The control device of claim 1, wherein said fiber was formed by one or more of melt spinning in the presence of said exfoliated nanoclay or by film-to-fiber processes in which an intercalated nanoclay containing said root-controlling agent is exfoliated in a polymer melt and extruded to form a film that is one or more of slit or chemomechanically fibrillated, and twisted to form fibers.

3. The control device of claim 1, wherein said root-controlling agent is one or more of 2,6-dinitroaniline, sodium methyldithiocarbamate (metam-sodium), methyl isothiocyanate, or copper sulfate.

4. The control device of claim 3, wherein said 2,6-dinitroaniline is selected from one or more of trifluralin, oryzalin, pendimethalin, isopropalin, diniramine, fluchloralin, benefin, dinoseb, or a salt thereof.

5. The control device of claim 1, wherein exfoliated nanoclay comprises one or more of smectite, bentonite, montmorillonite, beidellite, nonttronite, saponite, or sauconite.

6. The control device of claim 3, wherein exfoliated nanoclay comprises one or more of smectite, bentonite, montmorillonite, beidellite, nonttronite, saponite, or sauconite.

7. The control device of claim 1, wherein said fiber comprises a thermoplastic comprising one or more of polyurethane, polypropylene, polyethylene, ethylene/propylene copolymers, polyethylene terephthalate, polytrimethylene terephthalate, polyamides, polycaprolactone, polylactic acid, lactic acid-glycolic acid polyesters, or poly(3-hydroxy butyrate).

8. The control device of claim 6, wherein said fiber comprises a thermoplastic comprising one or more of polyurethane, polypropylene, polyethylene, ethylene/propylene copolymers, polyethylene terephthalate, polytrimethylene terephthalate, polyamides, polycaprolactone, polylactic acid, lactic acid-glycolic acid polyesters, or poly(3-hydroxy butyrate).

9. The control device of claim 1, which has been formed into one or more of a woven or nonwoven fabric.

10. The control device of claim 8, wherein said fabric is woven from a mixture of the fibers of claim 1 and fibers devoid of said root-controlling agent.

11. The control device of claim 3, which has been formed into one or more of a woven or nonwoven fabric.

12. The control device of claim 8, which has been formed into one or more of a woven fabric, a nonwoven fabric, or sandwiched between sheets of fabric.

13. The control device of claim 9, wherein fibers devoid of said root-controlling agent comprise fibers of one or more of cotton, rayon, cellulose pulp, flax, jute, hemp, wool, cellulose acetate, a vinyl, or an acrylic.

14. The control device of claim 1, which is blended with one or more of polymer-forming ingredients or an already formed polymer and formed into one or more of a geotextile, coating, a caulk, a sealant, or a gasket.

15. The control device of claim 14, wherein said polymer comprises one or more of polyurethane, polyethylene, polypropylene, polybutenes, natural rubber, polyisoprene, polyesters, styrene butadiene rubber, EPDM, polyacrylates, polymethacrylates, polyethylene terephthalate, polypropylene terephthalate, nylon 6, nylon 66, polylactic acid, polyhydroxy butyrate, polycarbonate, epoxy resins, or unsaturated polyester resins.

16. The control device of claim 1, wherein said root-controlling agent is heated to a temperature of at least about 5° C. above the root-controlling agent melting point temperature.

17. The control device of claim 16, wherein said root-controlling agent is heated to a temperature of at least about 10° C. above the root-controlling agent melting point temperature.

18. The control device of claim 1, wherein the particle size of the composite material is adjusted to less than about 35 microns when said control device is formed by melt spinning; and to less than about 20 microns when said control device is formed by injection molding.

19. The control device of claim 2, wherein the film is formed by one or more of extrusion, casting, injection molding, calendaring, or blow molding.

21. The control device of claim 1, which is in the form of a geotextile, coating, film, caulk, sealant, or gasket.

22. Method for forming a control device for control of one or more of root intrusion or plant growth, which comprises the steps of:
(a) heating a root-controlling agent to its melting point temperature;
(b) heating a nanoclay intercalated with an ammonium ion to a temperature of at least the root-controlling agent melting point temperature;
(c) loading said heated root-controlling agent with said heated intercalated ammonium ion intercalated nanoclay to form a composite material that is partially exfoliated;
(d) adjusting the particle size of said composite material for blending and further exfoliation;
(e) blending said particle size adjusted composite material with a polymer matrix;
(f) exfoliating the nanoclay in said polymer matrix to an extent that a slow controlled release of said root-controlling agent from said polymer matrix is obtained; and
(g) forming the polymer matrix of step (f) into a fiber to form said control device.

23. The method of claim 22, wherein said fiber is formed by one or more of melt spinning in the presence of said exfoliated nanoclay or by film-to-fiber processes in which an intercalated nanoclay containing said root-controlling agent is exfoliated in a polymer melt and extruded to form a film that is one or more of slit or chemomechanically fibrillated, and twisted to form fibers.

24. The method of claim 22, wherein said root-controlling agent is one or more of 2,6-dinitroaniline, sodium methyldithiocarbamate (metam-sodium), methyl isothiocyanate, or copper sulfate.

25. The method of claim 24, wherein said 2,6-dinitroaniline is selected from one or more of trifluralin, oryzalin, pendimethalin, isopropalin, diniramine, fluchloralin, benefin, dinoseb, or a salt thereof.

26. The method of claim 22, wherein exfoliated nanoclay comprises one or more of smectite, bentonite, montmorillonite, beidellite, nonttronite, saponite, or sauconite.

27. The method of claim 24, wherein exfoliated nanoclay comprises one or more of smectite, bentonite, montmorillonite, beidellite, nonttronite, saponite, or sauconite.

28. The method of claim 22, wherein said fiber comprises a thermoplastic comprising one or more of polyurethane, polypropylene, polyethylene, ethylene/propylene copolymers, polyethylene terephthalate, polytrimethylene terephthalate, polyamides, polycaprolactone, polylactic acid, lactic acid-glycolic acid polyesters, or poly(3-hydroxy butyrate).

29. The method of claim 26, wherein said fiber comprises a thermoplastic comprising one or more of polyurethane, polypropylene, polyethylene, ethylene/propylene copolymers, polyethylene terephthalate, polytrimethylene terephthalate, polyamides, polycaprolactone, polylactic acid, lactic acid-glycolic acid polyesters, or poly(3-hydroxy butyrate).

30. The method of claim 22, which has been formed into one or more of a woven or nonwoven fabric.

31. The method of claim 30, wherein said fabric is woven from a mixture of the fibers of claim 1 and fibers devoid of said root-controlling agent.

32. The method of claim 24, which has been formed into one or more of a woven or nonwoven fabric.

33. The method of claim 30, which has been formed into one or more of a woven fabric, a nonwoven fabric, or sandwiched between sheets of fabric.

34. The method of claim 31, wherein fibers devoid of said root-controlling agent comprise fibers of one or more of cotton, rayon, cellulose pulp, flax, jute, hemp, wool, cellulose acetate, a vinyl, or an acrylic.

35. The method of claim 22, which is blended with one or more of polymer-forming ingredients or an already formed polymer and formed into one or more of a geotextile, coating, a caulk, a sealant, or a gasket.

36. The method of claim 35, wherein said polymer comprises one or more of polyurethane, polyethylene, polypropylene, polybutenes, natural rubber, polyisoprene, polyesters, styrene butadiene rubber, EPDM, polyacrylates, polymethacrylates, polyethylene terephthalate, polypropylene terephthalate, nylon 6, nylon 66, polylactic acid, polyhydroxy butyrate, polycarbonate, epoxy resins, or unsaturated polyester resins.

37. The control device of claim 22, wherein said root-controlling agent is heated to a temperature of at least about 5° C. above the root-controlling agent melting point temperature.

38. The method of claim 37, wherein said root-controlling agent is heated to a temperature of at least about 10° C. above the root-controlling agent melting point temperature.

39. The method of claim 22, wherein the particle size of the composite material is adjusted to less than about 35 microns when said control device is formed by melt spinning; and to less than about 20 microns when said control device is formed by injection molding.

40. The method of claim 23, wherein the film is formed by one or more of extrusion, casting, injection molding, calendaring, or blow molding.

41. The method of claim 1, which is in the form of a geotextile, coating, film, caulk, sealant, or gasket.

42. In a method for controlling one or more of root intrusion or plant growth with a control device, the improvement which comprises:
controlling said one or more of root intrusion or plant growth with the control device of claim 1.

43. In a method for controlling one or more of root intrusion or plant growth with a control device, the improvement which comprises:
controlling said one or more of root intrusion or plant growth with the control device of claim 3.

44. In a method for controlling one or more of root intrusion or plant growth with a control device, the improvement which comprises:
controlling said one or more of root intrusion or plant growth with the control device of claim 5.

45. In a method for controlling one or more of root intrusion or plant growth with a control device, the improvement which comprises:
controlling said one or more of root intrusion or plant growth with the control device of claim 14.

46. In a method for controlling one or more of root intrusion or plant growth with a control device, the improvement which comprises:
controlling said one or more of root intrusion or plant growth with the control device of claim 15.
